(19) United States
(12) Patent Application Publication
(10) Pub. No.: US 2012/0162141 A1
(43) Pub. Date: Jun. 28, 2012

(54) TOUCH SCREEN DEVICE AND PLASMA DISPLAY APPARATUS HAVING THE SAME

(75) Inventors: Tadashi MAKI, Fukuoka (JP); Takashi KITADA, Fukuoka (JP)

(73) Assignee: PANASONIC CORPORATION, Osaka (JP)

(21) Appl. No.: 13/336,505

(22) Filed: Dec. 23, 2011

(30) Foreign Application Priority Data
Dec. 28, 2010 (JP) 2010-291488

(51) Int. Cl. G06F 3/042; G06F 3/041

(52) U.S. Cl. 345/175; 345/173

(57) ABSTRACT

A touch screen device includes a panel disposed in a front surface of a plasma display panel and having a plurality of transmitting electrodes and receiving electrodes intersecting in a grid pattern; a transmitter that applies a driving signal to the transmitting electrodes; and a receiver receiving a response signal and outputs detection data for each intersection between electrodes, the response signal being output from the receiving electrodes in response to the driving signal applied to the transmitting electrodes. A controller obtains a touch position based on detection data for each intersection, the data being output from the receiver; and a maintenance discharge detector detects a maintenance discharge period of the plasma display panel. The controller, based on a detection result of the maintenance discharge detector, obtains the touch position based on the detection data for each intersection during a period excluding the maintenance discharge period.

### CROSS-REFERENCE TO RELATED APPLICATIONS

The present application claims priority under 35 U.S.C. §119 of Japanese Application No. 2010-291488, filed on Dec. 28, 2010, the disclosure of which is expressly incorporated by reference herein in its entirety.

### BACKGROUND OF THE INVENTION

1. Field of the Invention

The present invention relates to a touch screen device provided on a front surface of a plasma display panel, and a plasma display apparatus having the touch screen device.

2. Description of Related Art

Various types having different principles to detect a touch position exist for touch screen devices. Among them, the types that configure a plurality of electrodes within one panel (e.g., resistance membrane type and electrostatic capacitance type) are susceptible to effects of outside noise, since the electrodes act as antennas. Especially, with the electrostatic capacitance type, noise can adversely affect accuracy of touch position detection to a great extent, because such touch position detection is performed by utilizing a minute change in electrostatic capacitance around an electrode when a conductive object (e.g., human body) approaches or contacts the electrode.

Normally, a touch screen device is used in combination of an image display apparatus such as a plasma display panel and an LCD display panel. When an image display apparatus is integrated with a touch screen device, however, the image display apparatus generates noise and decreases the accuracy of the touch position detection. Therefore, technology has been introduced in an attempt to decrease the adverse affect of noise generated from such an image display apparatus (See Related Art 1 and 2).

However, a plasma display panel has notable radiation noise output when discharge is made. Therefore, the conventional countermeasure for noise described above is not sufficient. The touch position detection accuracy is largely decreased, and practically sufficient detection accuracy has not been achieved with the conventional countermeasure.

[Related Art 1] Japanese Laid-Open Patent Publication No. S63-174120

[Related Art 2] Japanese Laid-Open Patent Publication No. 2010-009439

### SUMMARY OF THE INVENTION

The present invention is provided to address the above-described phenomenon in the conventional technology. The present invention provides a touch screen device configured to prevent a decrease of detection accuracy of a touch position, the decrease being caused by radiation noise generated from a plasma display panel, when the touch screen device is used in combination with the plasma display panel.

According to an aspect of the present invention, a touch screen device includes: a panel that is disposed in a front surface of a plasma display panel and that has a plurality of transmitting electrodes which are mutually arranged in parallel, and a plurality of receiving electrodes which are mutually arranged in parallel, the transmitting electrodes and the receiving electrodes intersecting in a grid pattern; a transmitter that applies a driving signal to the transmitting electrodes; a receiver that receives a response signal and outputs detection data for each intersection between electrodes, the response signal being output from the receiving electrodes in response to the driving signal applied to the transmitting electrodes; a controller that obtains a touch position based on detection data for each intersection, the data being output from the receiver; and a maintenance discharge detector that detects a maintenance discharge period of the plasma display panel. The controller, based on a detection result of the maintenance discharge detector, obtains the touch position based only on the detection data for each intersection during a period excluding the maintenance discharge period.

Accordingly, the touch position is obtained based solely on the detection data for each intersection, the data being obtained during a period excluding a maintenance charge period during which a large radiation noise is generated by the plasma display panel. Therefore, it is possible to avoid a situation where the touch position detection accuracy is lowered due to the radiation noise.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an overall configuration of a plasma display apparatus 1 according to the present invention;

FIG. 2 shows a schematic configuration of a reception signal processor 16;

FIGS. 3A-3C illustrate discharge control of a PDP 2;

FIG. 4 illustrates discharge control of the PDP 2;

FIGS. 5A and 5B illustrate a waveform of radiation noise of the PDP 2;

FIG. 6 shows a schematic configuration of an antenna reception circuit 19;

FIG. 7 is a flowchart illustrating a procedure performed by a controller 11 of a touch screen device 4;

FIG. 8 is a schematic cross section view illustrating a state where a panel 5 of the touch screen device 4 and the PDP 2 are integrated;

FIGS. 9A and 9B are schematic plan views illustrating the panel 5 of the touch screen device 4 and the PDP 2;

FIG. 10 is a plan view illustrating a transmitting electrode 7 and a receiving electrode 8;

FIG. 11 illustrates a schematic configuration of another example of a touch screen device according to the present invention;

FIGS. 12A and 12B illustrate a waveform of another example of a control method of the touch screen device according to the present invention; and

FIG. 13 is a flowchart illustrating a procedure performed by the controller 11.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

An embodiment of the present invention is provided as follows with reference to the drawings.

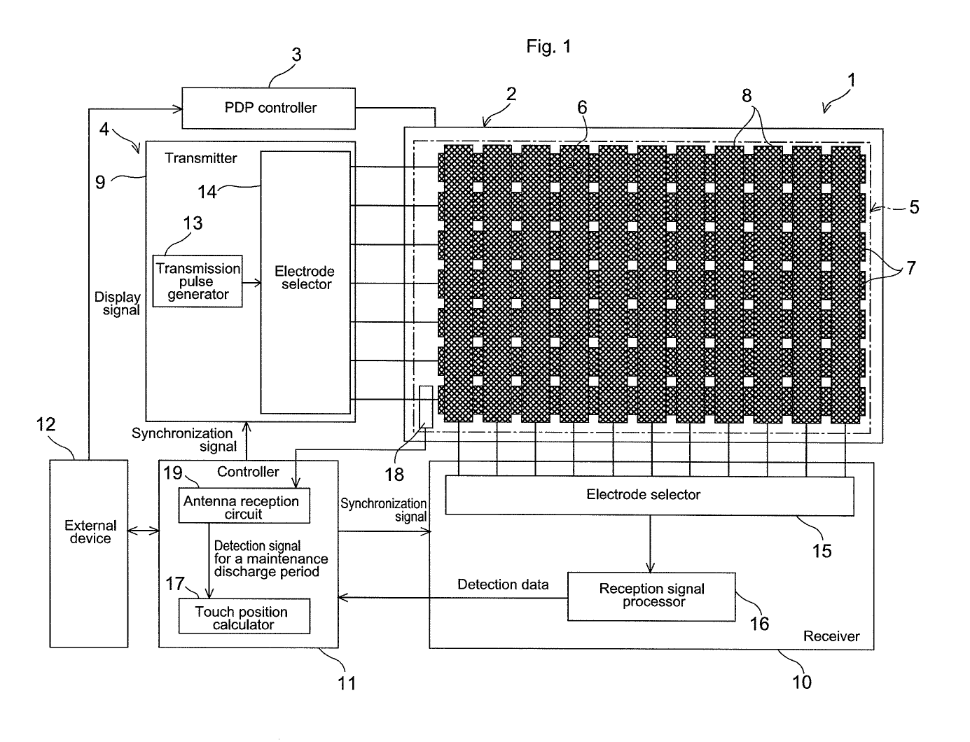

FIG. 1 shows an overall configuration of a plasma display apparatus 1 according to the present invention. The plasma display apparatus 1 is configured with a plasma display panel (hereafter referred to as PDP) 2, a PDP controller 3, and a touch screen device 4. A panel 5 of the touch screen device 4 is provided in a front side of a display surface of the PDP 2.

The panel 5 of the touch screen device 4 includes a touch surface 6 where a touch operation is performed by a pointing object (conductive body such as a finger tip of a user, a stylus, a pointing member or other such pointer). The touch surface is provided with a plurality of transmitting electrodes 7, which are mutually arranged in parallel, and a plurality of receiving electrodes 8, which are mutually arranged in parallel, the transmitting electrodes 7 and the receiving electrodes 8 crossing each other in a grid pattern.

In addition, the touch screen device 4 includes a transmitter 9, a receiver 10, and a controller 11. The transmitter 9 applies a driving signal to the transmitting electrodes 7. The receiver 10 receives a response signal of the receiving electrode 8 that has responded to the driving signal applied to the transmitting electrode 7, and outputs detection data for each electrode intersection where a transmitting electrode 7 and a receiving electrode 8 intersect. The controller 11 detects a touch position based on the detection data output from the receiver 10 and controls an operation of the transmitter 9 and the receiver 10.

The touch position information output from the controller 11 is input to an external device 12, such as a personal computer. Display screen data is generated in the external device 12 and is output to the PDP controller 3 that controls the PDP 2. Accordingly, when a user performs a touch operation using a pointing object on the touch surface 6 of the panel 5, an image is displayed on the screen of the PDP 2. Therefore, it becomes possible to display a required image as though a marker were used to directly draw on the touch surface 6, and to operate buttons and the like displayed on the display screen of the PDP 2. Further, an eraser that erases a drawn image through a touch operation may be used.

The transmitting electrodes 7 and the receiving electrodes 8 intersect in a stacked state having an insulating layer in between. A capacitor is formed on each electrode intersection where a transmitting electrode 7 and a receiving electrode 8 intersect. When the user performs a touch operation with a pointing object such as a finger and when the pointing object approaches or contacts the touch surface 6, in essence, electrostatic capacitance of the electrode intersection is decreased. Therefore, it is possible to detect whether or not the touch operation is performed.

In a mutual capacitance type touch screen device employed herein, a driving signal is applied to the transmitting electrodes 7, and then a charge-discharge current flows in the receiving electrodes 8 in response. The receiving electrodes 8 output the charge-discharge current as a response signal. A change in the electrostatic capacitance at the electrode intersections at this time in response to a user's touch operation causes a change in the charge-discharge current in the receiving electrodes 8, which is a change in the response signal. The change amount of the response signal is used to calculate a touch position. The detection data obtained after processing the reception signal by the receiver 10 is output for each electrode intersection of the transmitting electrode 7 and receiving electrode 8. Therefore, the mutual capacitance type enables multi-touch (multi-point detection) in which a plurality of touch positions are concurrently detected.

A touch position calculator 17 of the controller 11 obtains the touch position (center coordinate of a touch area) in a predetermined calculation process that uses detection data from each electrode intersection output from the receiver 10. In the touch position calculation, a touch position is obtained from detection data of each of a plurality of adjacent electrode intersections (for example, 4×4) in an X direction (direction in which the receiving electrodes 8 extend) and in a Y direction (direction in which the transmitting electrodes 7 extend) in a predetermined interpolating method (centroid method, for example). Thereby, the touch position can be detected at a higher resolution (1 mm or less, for example) than the placement pitch (10 mm, for example) of the transmitting electrodes 7 and the receiving electrodes 8.

The touch position calculator 17 of the controller 11 calculates a touch position every frame period at which reception of detection data ends for each electrode intersection across the entire surface of the touch surface 6, and outputs the touch position information to the external device 12 in a unit of frame. The external device 12 generates time-line connected display screen data of each touch position based on the touch position information of a plurality of temporally connected frames, and outputs the data to the PDP controller 3. In the case of multi-touch, the touch position information, including touch positions by a plurality of pointing objects, is output in a unit of frame.

The transmitter 9 includes a transmission pulse generator 13 that generates a pulse as a driving signal, and an electrode selector 14 that sequentially applies the pulse output from the transmission pulse generator 13 to the transmitting electrodes 7, by selecting each transmitting electrode 7 one by one.

The receiver 10 includes a reception signal processor 16 that processes a response signal output from the receiving electrodes 8, and an electrode selector 15 that sequentially inputs the reception signal from the receiving electrodes 8 to the reception signal processor 16, by selecting each receiving electrode 8 one by one.

The transmitter 9 and the receiver 10 operate according to a synchronization signal output from the controller 11. While a pulse signal is being applied to one transmitting electrode 7, a receiving electrode 8 is selected one by one, and a response signal from the receiving electrode 8 is sequentially input to the reception signal processor 16. When the above procedure is sequentially repeated for all of the transmitting electrodes 7, it is possible to retrieve all of the response signals from each electrode intersection.

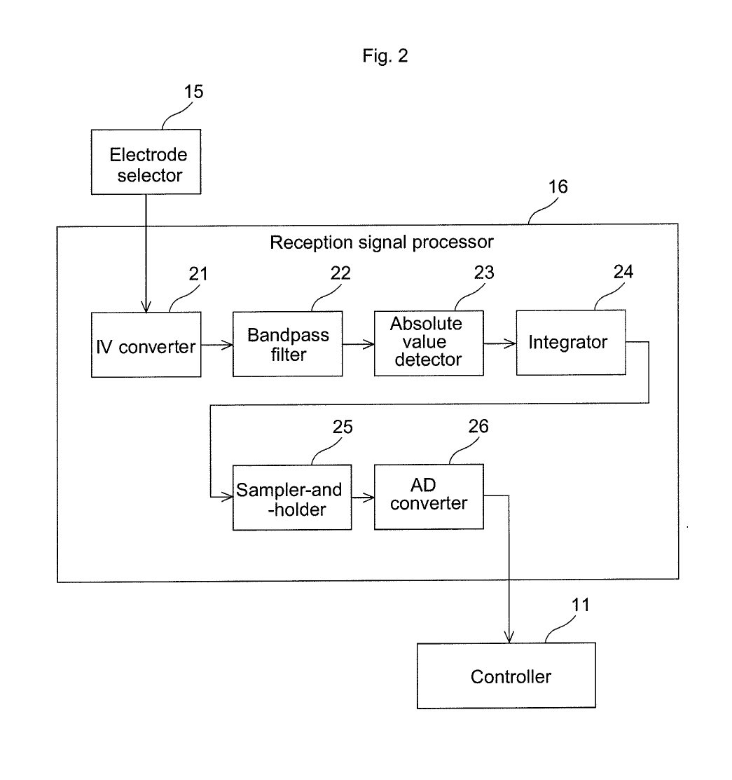

FIG. 2 illustrates a schematic configuration of the reception signal processor 16. The reception signal processor 16 includes an IV converter 21, a bandpass filter 22, an absolute value detector 23, an integrator 24, a sampler-and-holder 25, and an AD converter 26.

The IV converter 21 converts a response signal (charge-discharge current signal) into a voltage signal, the response signal being input from the receiving electrode 8 through the electrode selector 15. The bandpass filter 22 removes from the output signal of the IV converter 21, a signal having a frequency component other than a frequency of a driving signal applied to the transmitting electrode 7. The absolute value detector (such as, e.g., a rectifier) 23 performs full-wave rectification of the output signal from the bandpass filter 22. The integrator 24 integrates the output signal from the absolute value detector 23 in a time axis direction. The sampler-and-holder 25 samples the output signal from the integrator 24 at a predetermined timing. The AD converter 26 AD-converts the output signal from the sampler-and-holder 25 and outputs detection data (level signal) for each electrode intersection.

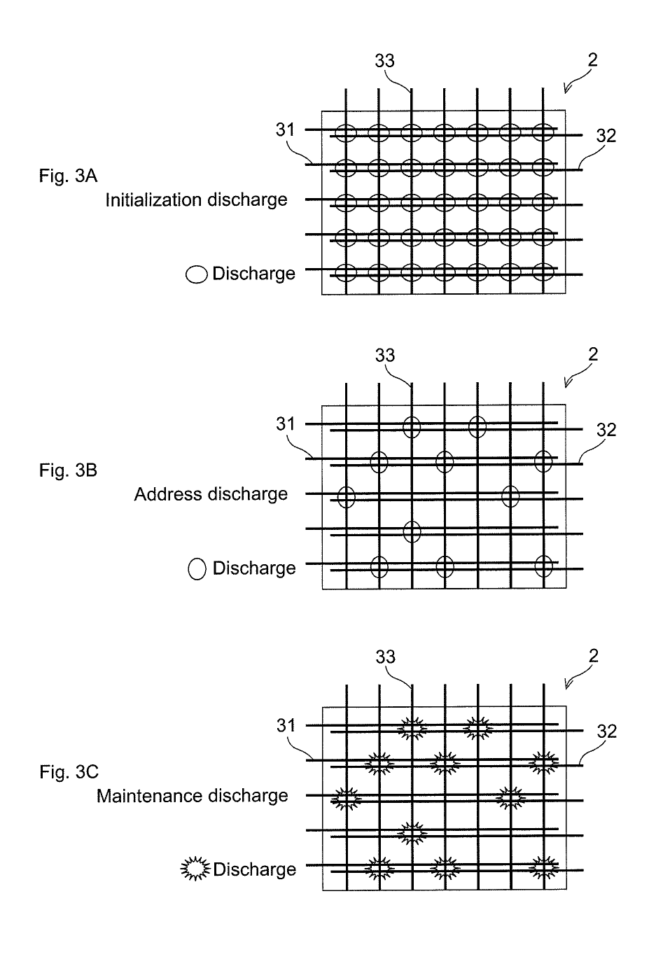

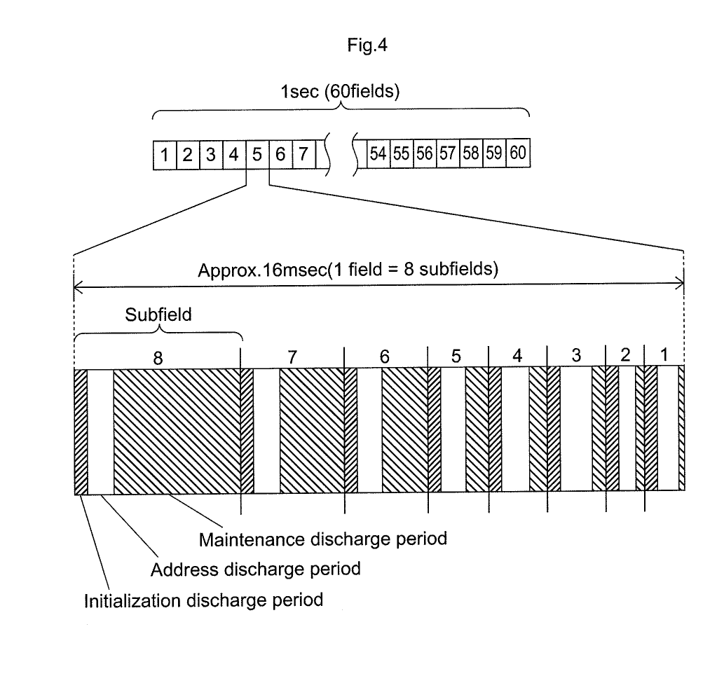

FIGS. 3A-3C and FIG. 4 are schematic drawings to illustrate discharge control of the PDP 2. As shown in FIGS. 3A-3C, the PDP 2 includes a maintenance electrode 31, a scanning electrode 32, and an address electrode 33. The maintenance electrode 31 and the scanning electrode 32 are provided in a mutually parallel orientation. The address electrode 33 is provided orthogonal to the maintenance electrode 31 and the scanning electrode 32. The PDP 2 is driven by an ADS (Address and Display period Separated) sub-field method. As shown in FIG. 4, one field is divided in to a plurality of subfields (8 subfields, in this example) on a time axis. Within each subfield, an initialization discharge, an address discharge, and a maintenance discharge are sequentially performed, which causes an image to be displayed with multiple tones.

As shown in FIG. 3A, a discharge is performed between the maintenance electrode 31 and the scanning electrode 32 during an initialization discharge, and this initialization discharge is performed simultaneously on all discharge cells. As shown in FIG. 3B, a discharge is performed between the scanning electrode 32 and the address electrode 33 during an address discharge, and a discharge cell located in an intersection of the scanning electrode 32 and the address electrode 33 is selected. As shown in FIG. 3C, a discharge is performed between the maintenance electrode 31 and the scanning electrode 32 during a maintenance discharge. Only the discharge cell selected during the address discharge performs a discharge, which causes a video image to be displayed.

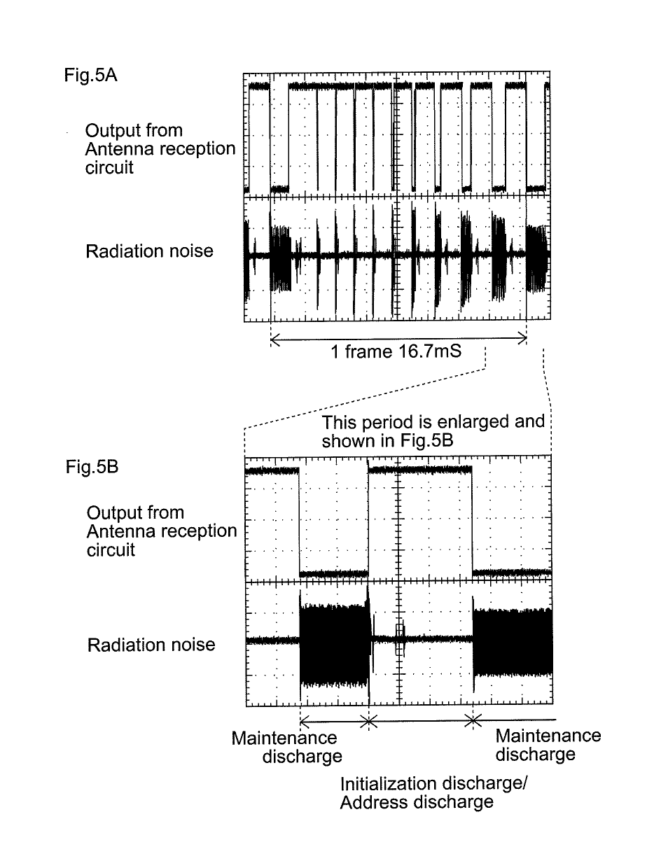

FIGS. 5A and 5B illustrate a waveform of a radiation noise of the PDP 2. A portion of FIG. 5A is enlarged and shown in FIG. 5B. While in each of the initialization discharge period, the address discharge period, and the maintenance discharge period, radiation noise is generated, particularly large radiation noise is generated during the maintenance discharge period, compared to the initialization discharge period and the address discharge period. This radiation noise causes an error in detecting a touch position. Therefore, in this example, as described below, a maintenance discharge period, where large radiation noise is generated, is detected in order to prevent occurrence of an error in detecting a touch position caused by the radiation noise.

As shown in FIG. 1, the touch screen device 4 has an antenna 18 that detects radiation noise from the PDP 2. The controller 11 has an antenna reception circuit (maintenance discharge detector) 19 that detects the maintenance discharge period of the PDP 2 based on an output signal of the antenna 18. The touch position calculator 17 uses the detection result of the antenna reception circuit 19 and obtains a touch position based only on detection data for each electrode intersection obtained during periods excluding the maintenance discharge period.

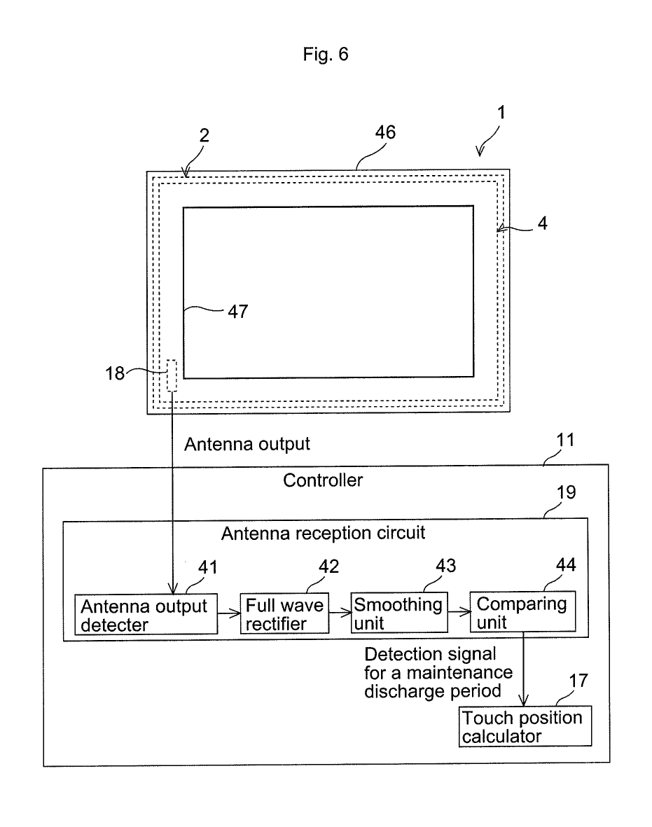

FIG. 6 shows a schematic configuration of the antenna reception circuit 19. The antenna reception circuit 19 processes an analog signal output from the antenna 18, and outputs a detection signal for a maintenance discharge period, indicating whether a maintenance discharge period has started. The antenna reception circuit 19 has an antenna output detector 41, a full wave rectifier 42, a smoothing unit (or a smoother) 43, and a comparing unit (or a comparator) 44.

In the antenna reception circuit 19, an output signal from the antenna 18 enters into the antenna output detector 41, and undergoes full wave rectification by the full wave rectifier 42. Then, the signal undergoes a smoothing process by the smoother 43 and a comparison with a predetermined threshold value by the comparing unit 44. Then, a detection signal for a maintenance discharge period is output, the signal indicating whether a maintenance discharge period has started. Since the PDP 2 has large radiation noise during a maintenance discharge period, it is possible to detect a maintenance discharge period with or based upon the level of the radiation noise (see FIGS. 5A and 5B). The detection signal for a maintenance discharge period may have a value of “1” during a maintenance discharge period, and a value of “0” during a period that is not a maintenance discharge period.

The antenna 18 may be configured by forming a conductive wire into a loop shape on a baseboard, and may further have a characteristic that a resonance frequency is proximate to an operation frequency of the PDP 2 to have an improved sensitivity. The antenna 18 is located outside the display area of the PDP 2, i.e., an area covered by a bezel 47 of a case 46 that contains the touch screen device 4 and the PDP 2.

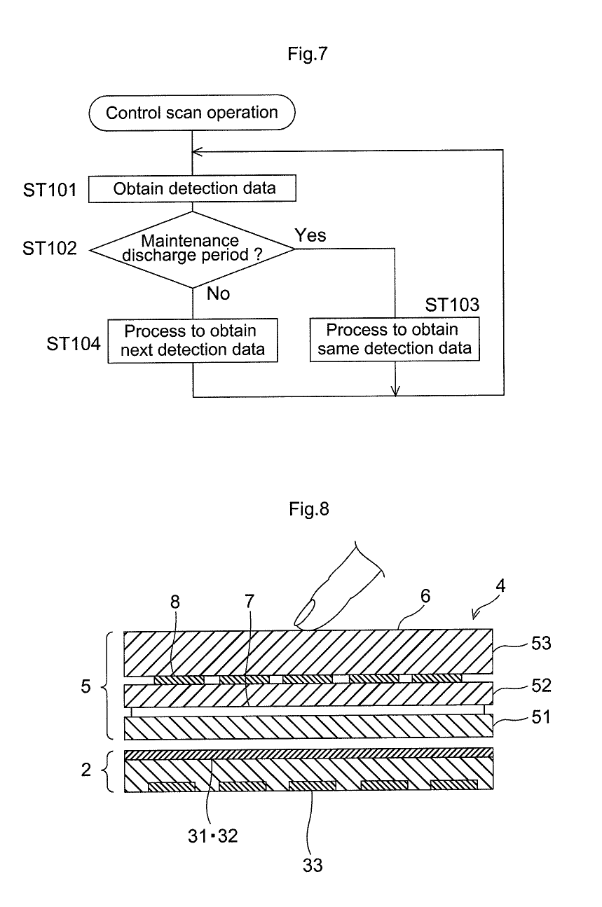

FIG. 7 is a flowchart illustrating a procedure performed by the controller 11 of the touch screen device 4. In this procedure, scanning operation, i.e., application of a driving signal to the transmitting electrode 7 by the transmitter 9 and a processing of an output signal from a receiving electrode 8 by the receiver 10, is performed regardless of whether or not the PDP 2 is in a maintenance discharge period. The detection data obtained during the maintenance discharge period is discarded, and the scanning operation is redone in order to recapture the discarded detection data from the electrode intersection.

Specifically, by performing the scanning operation, detection data for each electrode intersection is obtained (ST 101). When the detection signal for a maintenance discharge period indicates that the PDP 2 is in a maintenance discharge period, the signal being output from the antenna reception circuit 19 (Yes at ST 102), a process is performed to recapture the detection data of the same electrode intersection (ST 103). When the PDP 2 is not in a maintenance discharge period (No at ST 102), a process is performed to capture detection data of the next electrode intersection (ST 104).

By performing the scanning operation again after discarding the detection data obtained during the maintenance charge period, it is possible to obtain detection data for each electrode intersection for 1 frame, the data being obtained during non-maintenance charge periods only (i.e., initialization discharge period and address discharge period). When the detection data for 1 frame is ready, the touch position calculation process can be performed based on the detection data.

The controller 11 obtains from the receiver 10 detection data for each electrode intersection through the scanning operation. The controller 10 also simultaneously receives a detection signal for a maintenance discharge period from the antenna reception circuit 19, and determines whether the detection data is obtained during a maintenance discharge period (ST 102). Further, the discarding of the detection data and the re-scanning operation to re-obtain the detection data can be performed per one line that corresponds to one transmitting electrode 7.

As described above, the touch position is obtained based solely on the detection data for each electrode intersection, the data being obtained during periods excluding a maintenance charge period during which a large radiation noise is generated by the PDP 2. Accordingly, it is possible to avoid a situation where the touch position detection accuracy is lowered due to the radiation noise. Especially, the scanning operation is first performed regardless of whether a maintenance discharge period has started, then the detection data obtained during the maintenance discharge period is discarded, and the scanning operation is repeated. This makes it possible to obtain the detection data for each electrode intersection by effectively using the periods excluding the maintenance discharge period as much as possible. Therefore, the detection data for each electrode intersection for one frame can be efficiently obtained.

FIG. 8 is a schematic cross section view illustrating a state where the panel 5 of the touch screen device 4 and the PDP 2 are integrated. The transmitting electrodes 7 provided on the panel 5 of the touch screen device 4 are positioned on the PDP 2 side, while the receiving electrodes 8 are positioned on the touch surface 6 side opposite to the PDP 2. The transmitting electrodes 7 are formed on a transmitting electrode substrate 51, and the receiving electrodes 8 are formed on a receiving electrode substrate 52. Both the transmitting and receiving electrode substrates 51 and 52 are configured with a transparent insulating material, such as PET. A front surface side of the receiving electrodes 8 is provided with a front surface board 53 configuring a touch surface 6. The front surface board 53 is configured with a transparent insulating material such as glass. As described earlier, the PDP 2 includes the maintenance electrode 31, the scanning electrode 32, and the address electrode 33.

As described above, while the PDP 2 performs initialization discharge and address discharge during periods excluding a maintenance discharge period, the receiving electrodes 8 are provided spaced from the PDP 2, which makes it unlikely for the receiving electrodes 8 to pick up the radiation noise from the PDP 2. Therefore, in periods excluding a maintenance discharge period (i.e., during initialization discharge and address discharge periods), the effects of the radiation noise is suppressed.

Further, the touch screen device 4 can be configured to detect a touch operation by an electronic pen, as well as a finger. When a pen identification signal of an electronic pen is configured to be transmitted via the receiving electrodes 8, a plurality of electronic pens having different properties (such as drawn colors) can be used as needed, thereby enhancing the usability of the touch screen device. With this configuration, one may have a concern that the transmission of the pen identification signal may be interrupted by the radiation noise from the PDP 2. However, since the receiving electrodes 8 are positioned on the touch surface 6 side, the radiation noise from the PDP 2 does not have much impact. Therefore, it is possible to securely perform identification of the electronic pen through the use of the pen identification signal.

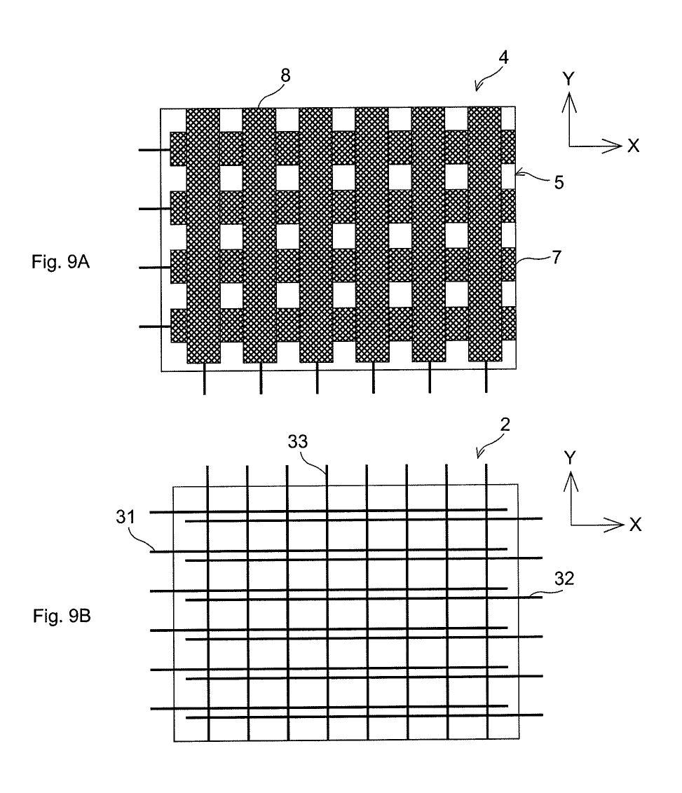

FIGS. 9A and 9B are schematic plan views illustrating the panel 5 of the touch screen device 4 and the PDP 2. As shown in FIG. 9A, in the panel 5 of the touch screen device 4, the transmitting electrodes 7 extend in an X direction, and the receiving electrodes 8 extend in a Y direction. Meanwhile, as shown in FIG. 9B, in the PDP 2, the maintenance electrodes 31 and the scanning electrodes 32 extend in the X direction, and the address electrodes 33 extend in the Y direction. Accordingly, the receiving electrodes 8 of the touch screen device 4 are provided in a direction orthogonal to the scanning electrodes 32 of the PDP 2.

As described above, while the PDP 2 performs initialization discharge and address discharge during periods excluding a maintenance discharge period, the radiation noise of the PDP 2 is mainly caused by the scanning electrodes 32. Since the receiving electrodes 8 are provided in the direction orthogonal to the scanning electrodes 32, it is unlikely for the receiving electrodes 8 to pick up the radiation noise. Therefore, in periods excluding a maintenance discharge period (i.e., during initialization discharge and address discharge periods), the effects of the radiation noise is suppressed.

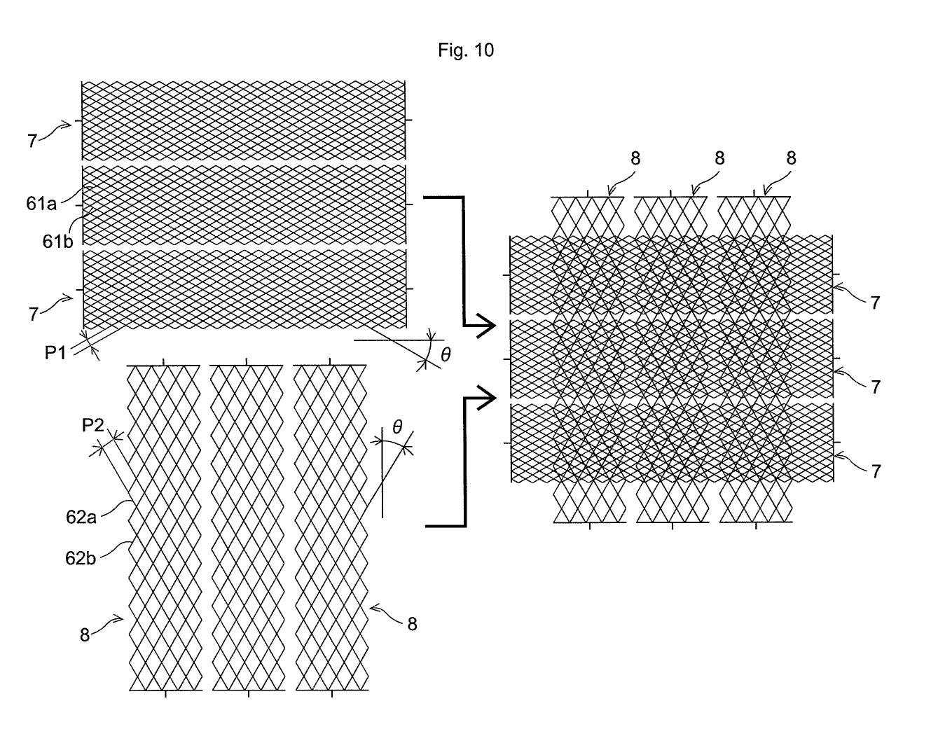

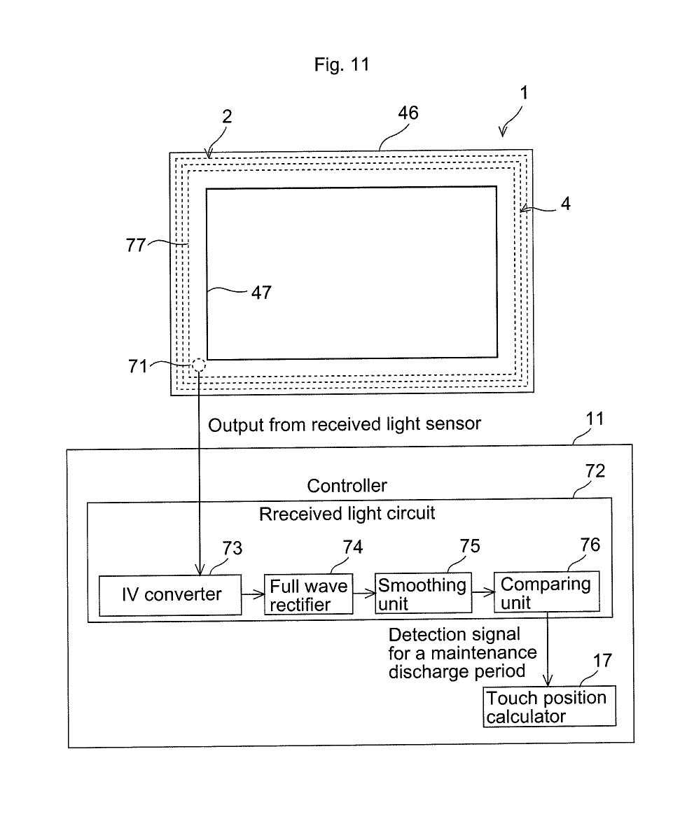

FIG. 10 is a plan view illustrating the transmitting electrodes 7 and the receiving electrodes 8. Each of the transmitting electrodes 7 is configured with a mesh-like electrode shape in which conductive wires 61a and 61b are arranged in a grid pattern. The conductive wires 61a extend in a direction inclined at a predetermined angle θ toward a clockwise direction with respect to the longitudinal direction of the transmitting electrode 7. The conductive wires 61b extend in a direction inclined at a predetermined angle θ toward a counterclockwise direction with respect to the longitudinal direction of the transmitting electrode 7. With the intersection angle 2θ between the conductive wire 61a and the conductive wire 61b being less than 90 degree, the conductive wire 61a and the conductive wire 61b form a consecutive diamond-shape grid pattern. The conductive wires 61a and 61b are electrically connected to each other at crossing (or intersecting) portions.

Similar to the transmitting electrodes 7, each of the receiving electrodes 8 is also configured with a mesh-like electrode shape in which conductive wires 62a and 62b are arranged in a grid pattern. The arrangement of the conductive wires 62a and 62b is similar to that of the conductive wires 61a and 61b of the transmitting electrode 7, while a mesh pitch P2 of the receiving electrode 8 is configured greater than a mesh pitch P1 of the transmitting electrode 7 (P1<P2).

With the transmitting electrodes 7 and the receiving electrodes 8 configured as described above, by forming the conductive wires 61a, 61b, 62a, and 62b to have a minute wire diameter, the transmitting electrodes 7 and the receiving electrodes 8 become almost invisible. Thus, it is possible to improve visibility of a screen of the PDP 2 placed in the rear surface of the touch screen device 4. In addition, it is also possible to inhibit a moire that occurs when the transmitting electrode 7 and the receiving electrode 8 overlap with a pixel pattern of the PDP 2. Further, by having a greater mesh pitch of the receiving electrodes 8, a variation rate of a response signal caused by a touch operation increases, thereby making it possible to improve the detection accuracy of a touch position.

In addition, as shown in FIG. 8, since the transmitting electrodes 7 provided on the PDP 2 side have a mesh-like electrode shape, a shielding effect that shields a radiation noise from the PDP 2 can be obtained. By providing a smaller mesh pitch for the transmitting electrodes 7, it is possible to improve the shielding effect by the transmitting electrodes 7. Further, when selecting one of the transmitting electrodes 7 by the electrode selector 15 of the transmitter 9 and applying a driving signal to the electrode, the shielding effect can be further improved by ground-connecting the non-selected transmitting electrodes 7.

FIG. 11 illustrates a schematic configuration of another example of a touch screen device according to the present invention. In this example, points different from the previous example are illustrated. The configurations of other components are similar to the previous example.

In this example, instead of the antenna 18 and the antenna reception circuit 19 in the previous example, a light sensor 71 and a received light circuit (maintenance discharge detector) 72 are provided. The light sensor 71 detects discharge light of the PDP 2. The received light circuit 72 detects the maintenance discharge period of the PDP 2 based on an output signal from the light sensor 71. Since in the PDP 2, a pixel (discharge cell) emits light during the maintenance discharge period, it is possible to detect the maintenance discharge period by configuring the light sensor 71 to detect the discharge light of the PDP 2.

The received light circuit 72 processes an analog signal output from the light sensor 71, and outputs a detection signal for a maintenance discharge period indicating whether a maintenance discharge period has started. The received light circuit 72 includes an IV converter 73, a full wave rectifier 74, a smoothing unit (or a smoother) 75, and a comparing unit (or a comparator) 76. In the received light circuit 72, IV converting, full wave rectifying, and smoothing processes are performed in response to an output signal from the light sensor 71. The comparing unit 76 then outputs a detection signal for a maintenance discharge period indicating whether a maintenance discharge period has started, after comparison with a predetermined threshold value. Since, in the PDP 2, a discharge cell emits light during the maintenance discharge period, it is possible to detect the maintenance discharge period based upon the existence of the light emission.

For example, the light sensor 71 may be configured with a photo diode and be provided at a location covered by the bezel 47 of the case 46, especially on a perimeter frame portion of a display region 77 (of the PDP 2) outside the area where an image is actually displayed. Further, it is preferable that all sub-fields perform maintenance discharge by always lighting the pixels in a region monitored by the light sensor 71, in the display region 77 of the PDP 2. Additionally, the light sensor 71 may be configured to detect one of visible light and infrared light.

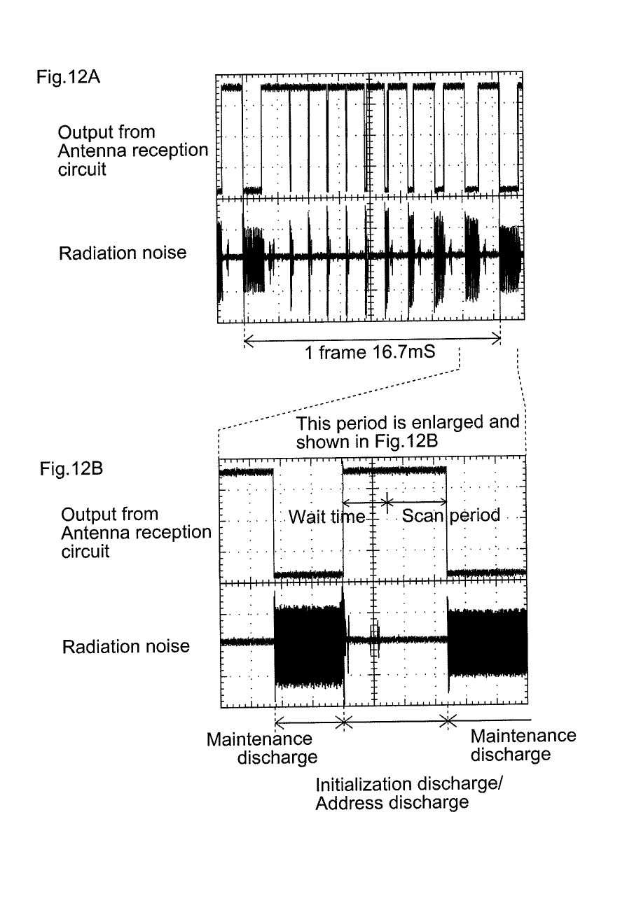

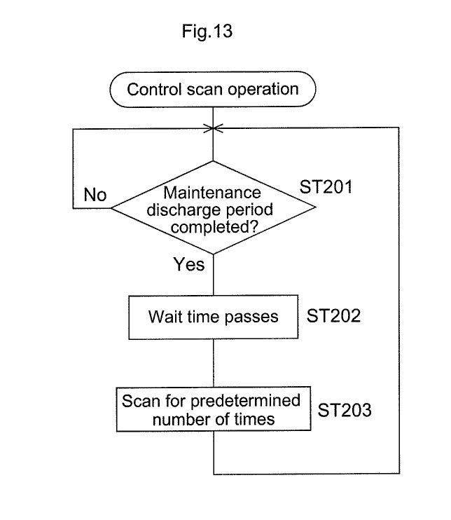

FIGS. 12A and 12B illustrate a waveform of another example of a control method of the touch screen device according to the present invention. FIG. 13 is a flowchart illustrating a procedure performed by the controller 11.

In this example, the scanning operation is performed by avoiding the maintenance discharge period, the scanning operation applying a driving signal from the transmitter 9 to the transmitting electrodes 7 and processing an output signal from the receiving electrodes 8 by the receiver 10. Then, based on the detection data obtained from each electrode intersection, a touch position is obtained. Further, in this example, the scanning operation is performed having a predetermined waiting time after a maintenance discharge is completed.

Specifically, as shown in FIG. 13, when the detection signal for a maintenance discharge period output from the antenna reception circuit 19 indicates that the maintenance discharge period has been completed (Yes in ST 201), a predetermined waiting time elapses (ST 202), and the scanning operation is performed predetermined number of times (ST 303). In this example, the scanning operation for one line corresponding to one transmitting electrode 7 is repeated for a predetermined number of times (10 times, for example), and detection data for each electrode intersection of the predetermined number of lines is obtained.

As described above, the scanning operation for one line is repeated a predetermined number of times, in response to a completion of the maintenance discharge period, and detection data for each electrode intersection of a predetermined number of lines is obtained. This is repeated at each completion of the maintenance discharge period. Therefore, it is possible to obtain detection data for each electrode intersection per frame. When all of the detection data for one frame is obtained, the touch position calculation process based on the detection data is performed.

The above-described process performed in the controller 11 is realized by performing or executing a predetermined program in a CPU. The above-described process is performed when the CPU interrupts in response to a detection signal for a maintenance discharge period, which is output by the antenna reception circuit 19.

A processing method shown in FIG. 13 is preferably used when a maintenance discharge is performed every sub-field, as shown in FIG. 4, and a period is observed where radiation noise is periodically lowered every time a maintenance discharge is completed (initialization discharge period and address discharge period). Alternatively, the maintenance discharge in the sub-field maybe omitted as needed. In this case, however, since the maintenance discharge is not periodically performed, the processing method illustrated in FIG. 7 is preferable.

Further, in the example shown above, the antenna 18 is provided in order to detect the radiation noise from PDP 2 as illustrated in FIG. 1. However, it is possible to have a configuration where the radiation noise is detected by the receiving electrodes 8. In this case, the radiation noise detection can be simply performed when one of the receiving electrodes 8 is used as a dummy electrode that is not used for the touch position detection.

Furthermore, while the maintenance discharge period of the PDP 2 is detected based on the radiation noise and discharge light from the PDP 2, the PDP 2 can alternatively be configured to output a signal indicating whether the maintenance discharge period has started, so that the touch screen device 2 can detect the maintenance discharge period based on such a signal. In this case, however, the PDP 2 needs to have an outputter that generates and outputs a signal. Instead, when the maintenance discharge period is detected based on the radiation noise and discharge light of the PDP 2, there is no need to add a separate component to the PDP 2. Therefore, it is possible to easily provide the touch position detection that does not cause an increase in the production cost.

Accordingly, the touch screen device and the plasma display apparatus having the same according to the present invention can prevent the radiation noise of the plasma display panel from deteriorating detection accuracy of the touch position. Therefore, the invention can be advantageously used in the touch screen device positioned in a front surface of a plasma display panel, and the plasma display apparatus having the same.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A touch screen device comprising:
a panel that is disposed in a front surface of a plasma display panel and that has a plurality of transmitting electrodes which are mutually arranged in parallel, and a plurality of receiving electrodes which are mutually arranged in parallel, the transmitting electrodes and the receiving electrodes intersecting in a grid pattern;
a transmitter that applies a driving signal to the transmitting electrodes;
a receiver that receives a response signal and outputs detection data for each intersection between electrodes, the response signal being output from the receiving electrodes in response to the driving signal applied to the transmitting electrodes;
a controller that obtains a touch position based on detection data for each intersection, the data being output from the receiver; and
a maintenance discharge detector that detects a maintenance discharge period of the plasma display panel, wherein
the controller, based on a detection result of the maintenance discharge detector, obtains the touch position based only on the detection data for each intersection during a period excluding the maintenance discharge period.

2. The touch screen device according to claim 1, wherein the transmitting electrodes are disposed on a side of the panel facing the plasma display panel, and the receiving electrodes are disposed on a side of the panel opposite to the plasma display panel.

3. The touch screen device according to claim 1, wherein the receiving electrodes extend in a direction orthogonal to scanning electrodes of the plasma display panel.

4. The touch screen device according to claim 1, wherein both the transmitting electrodes and the receiving electrodes are configured as mesh-like electrodes in which conductive wires are arranged in a grid pattern.

5. The touch screen device according to claim 4, wherein a mesh pitch of the receiving electrodes is greater than a mesh pitch of the transmitting electrodes.

6. The touch screen device according to claim 1, wherein the controller
performs a scanning operation regardless of whether the plasma display panel is in a maintenance discharge period, the scanning operation applying a driving signal to the transmitting electrodes by the transmitter and processing an output signal from the receiving electrodes by the receiver;
discards the detection data obtained during the maintenance discharge period based on the detection result of the maintenance discharge detector; and
performs the scanning operation again in order to recapture the discarded detection data from the electrode intersection.

7. The touch screen device according to claim 1, wherein the maintenance discharge detector detects a maintenance discharge period of the plasma display panel based upon an output signal of an antenna that detects a radiation noise from the plasma display panel.

8. The touch screen device according to claim 1, wherein the maintenance discharge detector detects a maintenance discharge period of the plasma display panel based upon an output signal of a light sensor that detects discharge light from the plasma display panel.

9. A plasma display apparatus comprising:
the touch screen device according to claim 1 positioned on a front surface of the plasma display panel.

10. The touch screen device according to claim 8, the maintenance discharge detector further comprising a received light circuit that receives the output signal of the light sensor and outputs a signal indicating that the maintenance discharge period has started.

11. The touch screen device according to claim 10, wherein the received light circuit compares a signal based upon the output signal from the light sensor with a threshold value to determine the start of the maintenance discharge period.

12. The touch screen device according to claim 8, said light sensor comprising a photo diode configured to detect infrared light.

13. The touch screen device according to claim 1, wherein the controller obtains the touch position based only on the detection data for each intersection between electrodes during a period excluding the maintenance discharge period by performing a scanning operation upon completion of a predetermined wait time after a maintenance discharge is completed.

14. The touch screen device according to claim 1, wherein said maintenance discharge detector comprises one of said receiving electrodes that is configured to detect radiation noise emitted during the maintenance discharge period.

15. The touch screen device according to claim 1, wherein said maintenance discharge detector detects a signal output from the plasma display panel indicating that the maintenance discharge period has started.

16. The plasma display apparatus according to claim 9, the plasma display panel comprising a plurality of maintenance electrodes extending parallel to each other, a plurality of scanning electrodes extending parallel to each other and parallel to the plurality of maintenance electrodes, and a plurality of address electrodes extending parallel to each other and substantially orthogonal to the maintenance electrodes and to the scanning electrodes, and the receiving electrodes of the touch screen device extend in a direction orthogonal to the scanning electrodes.

17. The plasma display device according to claim 9, further comprising a controller that drives the plasma display panel in accordance with an Address and Display period Separated (ADS) sub-field method.

18. The touch screen device according to claim 7, the maintenance discharge detector comprising an antenna reception circuit that detects the maintenance discharge period based on an output signal of the antenna, the antenna reception circuit compares a signal based upon the output signal from the antenna with a threshold value to determine the start of the maintenance discharge period.
